(19) United States
(12) Patent Application Publication
(10) Pub. No.: US 2025/0093588 A1
(43) Pub. Date: Mar. 20, 2025

(54) OPTICAL CONNECTOR AND ACTIVE OPTICAL CABLE USING THE SAME

(71) Applicant: OPTOMIND INC., Suwon-si Gyeonggi-do (KR)

(72) Inventors: Hyun Ryong CHO, Suwon-si Gyeonggi-do (KR); Yong Geon LEE, Hwaseong-si Gyeonggi-do (KR); Yung Sung SON, Suwon-si Gyeonggi-do (KR)

(73) Assignee: OPTOMIND INC., Suwon-si Gyeonggi-do (KR)

(21) Appl. No.: 18/426,518

(22) Filed: Jan. 30, 2024

(30) Foreign Application Priority Data
Sep. 19, 2023 (KR) 10-2023-0124918

(51) Int. Cl. G02B 6/38

(52) U.S. Cl. CPC G02B 6/3829; G02B 6/3853

(57) ABSTRACT

The present disclosure relates to an optical connector and an active optical cable using the same. The optical connector includes an optical boundary surface on which light emitted from an optical fiber is incident; a reflector changing the direction of traveling of light incident through the optical boundary surface; and a lens emitting light reflected through the reflector outside. The reflector has a cylindrical shape and converts light incident on the reflector into light traveling parallel to a first direction, and the lens has a cylindrical shape and converts light incident on the lens into light traveling parallel to a second direction which is perpendicular to the first direction.

### CROSS-REFERENCE TO RELATED APPLICATION

This application claims priority to Korean Patent Application No. 10-2023-0124918, filed on Sep. 19, 2023, the entire contents of which are herein incorporated by reference.

### Technical Field

The present disclosure relates to an optical connector and an active optical cable (AOC) using the same. More specifically, the present disclosure relates to an optical connector for easy optical alignment and an active optical cable using the same which is designed as a modular type for easy assembly and repair.

### Background Art

An active optical cable has an optical fiber cable and an optical transceiver located at both ends thereof connected to form a single component assembly. Optical transceivers perform photoelectric conversion and optical transmission/reception functions, and is compatible with standard electrical interfaces, increasing transmission speed and distance using optical cables. For example, optical transceivers may include standard electrical interfaces such as a gigabit interface converter (GBIC), small form-factor pluggable (SPF), SPF+, XFP, QSPF, QSFP+, QSFP28, CFP, etc.

Active optical cables are mainly used to connect switches, servers, and storage inside data centers, and are also used for high-speed, large-capacity data transmission in servers, high-performance computers, mass storage, and high-resolution displays. Compared to direct attach cables (DACs) or active copper cables (ACCs) that use copper wires, active optical cables have the advantages of being light in weight, having a long transmission distance, easy wiring, and being resistant to electromagnetic interference.

However, active optical cables are more expensive than DACs and ACCs due to the optical transceivers. Since a conventional active optical cable is implemented as a single component assembly, the entire active optical cable must be replaced even when only some components of the active optical cable are damaged. For example, if an optical fiber is damaged, if the connection between the optical fiber and one optical transceiver is damaged, or if only one optical transceiver is damaged, the entire active optical cable must be replaced with a new product.

In addition, conventional active optical cables require precise optical alignment between optical components inside the optical transceiver and optical fibers during the manufacturing process of combining optical fibers and optical transceivers, which complicates the manufacturing process and increases the cost.

As a result, there has been a need for modular-type active optical cables that are easy to assemble and repair, but the prior art has been unable to provide them. The present disclosure is intended to address this need.

### DETAILED DESCRIPTION

### Technical Challenges

It is an object of the present disclosure to provide a modular-type active optical cable.

It is another object of the present disclosure to provide an active optical cable that is easy to be repaired when some components constituting the active optical cable are damaged.

It is yet another object of the present disclosure to provide an optical connector that is easy to be optically aligned during the assembly process and is resistant to noise caused by dust, etc.

It is yet another object of the present disclosure to provide an optical connector that is easy to be molded and reduces geometric errors.

It is yet another object of the present disclosure to reduce interference caused by reflections that may occur at the boundary surface between the components constituting the active optical cable.

The objects of the present disclosure are not limited to those mentioned above, and other objects and advantages of the present disclosure that are not mentioned above can be understood from the following description, and will be more clearly understood from the embodiments of the present disclosure. It will also be easily understood that the objects and advantages of the present disclosure can be realized by the means and combinations of means disclosed in the claims.

### Means for Solving the Technical Challenges

In order to achieve the technical task, the optical connector according to an embodiment of the present disclosure comprises: an optical boundary surface on which light emitted from an optical fiber is incident; a reflector changing the direction of traveling of light incident through the optical boundary surface; and a lens emitting light reflected through the reflector outside, wherein the reflector has a cylindrical shape and converts light incident on the reflector into light traveling parallel to a first direction, and the lens has a cylindrical shape and converts light incident on the lens into light traveling parallel to a second direction which is perpendicular to the first direction.

According to an embodiment of the present disclosure, the first direction may be perpendicular to both the direction of light incident on the reflector and the direction of reflection.

According to an embodiment of the present disclosure, the second direction may be perpendicular to both the direction of light incident on the lens and the first direction.

According to an embodiment of the present disclosure, the light emitted through the lens may have a wider width in the second direction than in the first direction and may travel in parallel.

According to an embodiment of the present disclosure, the reflector may be a prism in the form of a cylindrical lens.

According to an embodiment of the present disclosure, the lens may be a cylindrical lens.

According to an embodiment of the present disclosure, the direction of light incident on the lens may be changed by the reflector to be incident on the optical fiber.

According to an embodiment of the present disclosure, the optical connector may be bottom-to-bottom coupled to another optical connector.

According to an embodiment of the present disclosure, the optical connector, when coupled to another optical connector, may have a lens of the optical connector facing a lens of the another optical connector.

According to an embodiment of the present disclosure, the optical connector may comprise parts coupled in a gradient structure in opposite directions to each other when coupled with another optical connector.

According to an embodiment of the present disclosure, the parts coupled in a gradient structure in opposite directions to each other may be a coupling protrusion and a front side part.

According to an embodiment of the present disclosure, the optical connector may comprise guide parts formed at opposite inclinations to each other to guide smooth coupling when coupled with another optical connector.

According to an embodiment of the present disclosure, the optical connector may be coupled with a plurality of optical fibers, may comprise reflectors in equal numbers as the optical fibers, and may comprise the one lens.

According to an embodiment of the present disclosure, the optical connector may comprise a body part and a cover part.

According to an embodiment of the present disclosure, the cover part and the body part may have protrusions and grooves fittedly coupled to each other.

According to an embodiment of the present disclosure, the body part may comprise an optical fiber guide capable of seating at least one optical fiber.

In order to achieve the technical task, the optical cable module according to an embodiment of the present disclosure comprises the optical connector according to an embodiment of the present disclosure.

In order to achieve the technical task, the optical transceiver module according to an embodiment of the present disclosure comprises the optical connector according to an embodiment of the present disclosure.

In order to achieve the technical task, the active optical cable according to an embodiment of the present disclosure comprises: an optical cable module comprising the optical connector according to an embodiment of the present disclosure; and an optical transceiver module comprising the optical connector according to an embodiment of the present disclosure.

In order to achieve the technical task, the active optical cable according to an embodiment of the present disclosure comprises: two optical cable modules; and an optical transceiver module comprising two insertion holes, wherein the optical cable module comprises the optical connector of claim 1, the insertion hole allows the optical cable modules to be coupled one by one, and the insertion hole comprises the optical connector of claim 1.

### Effect of Invention

The modular-type active optical cable according to the present disclosure has an effect of being easy to repair when some of the components are damaged.

In addition, according to the present disclosure, there is an effect in that optical alignment can be easily adjusted when assembling an active optical cable.

The present disclosure has an effect of providing an optical connector that is easy to be optically aligned and is resistant to noise caused by dust, etc.

The present disclosure has an effect of providing an optical connector that is easy to be molded and reduces geometric errors, thereby reducing costs.

In addition, the present disclosure has an effect of reducing interference caused by reflections that may occur at the interface between the components constituting the active optical cable.

In addition to the foregoing, specific effects of the present disclosure are set forth below, describing the specifics for carrying out the present disclosure.

### BRIEF DESCRIPTION OF DRAWINGS

FIG. 1 is a conceptual diagram illustrating the structure of an active optical cable according to an embodiment of the present disclosure;

FIG. 2 is a block diagram illustrating the external structure of an active optical cable according to an embodiment of the present disclosure;

FIG. 3 is a block diagram illustrating the external structure of an active optical cable according to another embodiment of the present disclosure;

FIG. 4 is a block diagram illustrating the external structure of a cable adaptor and an optical cable module coupled thereto according to another embodiment of the present disclosure;

FIGS. 5, 6, 7A,7B, 7C, 8, and 9 are block diagrams illustrating coupling structures of an optical connector 500 for optical coupling according to an embodiment of the present disclosure;

FIGS. 10A and 10B are a top perspective view and a bottom perspective view of a body part configuring an optical connector according to an embodiment of the present disclosure;

FIGS. 11A, 11B, and 11C are conceptual diagrams illustrating an optical path after coupling optical connectors according to an embodiment of the present disclosure;

FIG. 12 is a conceptual diagram illustrating the shape of an optical beam by a cylindrical lens;

FIG. 13 is a conceptual diagram illustrating the traveling of light when the reflector and the lens are cylindrical lens according to an embodiment of the present disclosure;

FIG. 14 is a cross-sectional view illustrating the interior of the active optical cable of FIG. 3 according to an embodiment of the present disclosure;

FIGS. 15A and 15B are cross-sectional views illustrating the interior of the optical cable adapter of FIG. 4 according to an embodiment of the present disclosure;

FIGS. 16A, 16B, and 16C are a perspective view and a cross-sectional view illustrating the configuration of an optical cable module according to an embodiment of the present disclosure;

FIGS. 17A, 17B, 17C, 17D, and 17E are perspective views and cross-sectional views illustrating the configuration of a housing part according to an embodiment of the present disclosure;

FIGS. 18A, 18B, 18C, and 18D are perspective views and cross-sectional views illustrating the configuration of a cassette part according to an embodiment of the present disclosure;

FIGS. 19A and 19B are a perspective view and a cross-sectional view illustrating the configuration of a cassette part to which an optical connector is coupled according to an embodiment of the present disclosure;

FIGS. 20A, 20B, and 20C are perspective views illustrating the configuration of a second optical transceiver module according to an embodiment of the present disclosure;

FIGS. 21A, 21B, 21C, and 21D are perspective views and cross-sectional views of a cassette part used in a second optical transceiver module according to an embodiment of the present disclosure;

FIGS. 22A, 22B, 22C, 23A, 23B, and 23C are exploded perspective views illustrating a housing part used in a second optical transceiver module according to an embodiment of the present disclosure;

FIGS. 24A, 24B, and 24C are a top perspective view, a bottom perspective view, and a coupled view of a divider insert according to an embodiment of the present disclosure;

FIGS. 25A and 25B are cross-sectional views illustrating a coupling method of optical connectors in an optical cable module according to an embodiment of the present disclosure; and

FIGS. 26A, 26B, and 26C are cross-sectional views illustrating a coupling method of optical connectors in a second optical transceiver module according to an embodiment of the present disclosure.

### DETAILED DESCRIPTION

In order to clarify the technical idea of the present disclosure, embodiments of the present disclosure are described in detail with reference to the accompanying drawings. In describing the present disclosure, where it is deemed that a detailed description of the relevant known components or features would unnecessarily obscure the gist of the invention, the detailed description is omitted. In the drawings, components having substantially the same functional configuration are assigned the same reference numerals and symbols wherever possible, even if they are shown in different drawings. For the sake of convenience in explanation, apparatus and methods are described together where necessary. Each operation of the present disclosure does not have to be performed in the order described and may be performed in parallel, optionally, or separately.

The terms used in the embodiments of the present disclosure have been chosen to be as generic as possible in current popular usage while taking into account the functions of the present disclosure, but may vary depending on the intent or precedent of a person skilled in the art, the emergence of new technologies, etc. In addition, in certain cases, terms have been arbitrarily selected by the applicant, in which case their meaning will be described in detail in the description of the applicable embodiment. Accordingly, terms used herein should be defined not merely by the name of the term, but by the meaning of the term and the context in the present disclosure as a whole.

Throughout the present disclosure, expressions in the singular may include the plural unless the context clearly indicates otherwise. Terms such as “comprise” or “have” are intended to designate the presence of a feature, number, step, action, component, part, or combination thereof, and not to preclude the possibility of the presence or addition of one or more other features, numbers, steps, actions, components, parts, or combinations thereof. In other words, throughout the present disclosure, when a part is said to “comprise” a component, it is meant to be inclusive of other components, not exclusive of other components, unless specifically stated to the contrary.

Expressions such as “at least one” modify the entire list of components, not the components of the list individually. For example, “at least one of A, B, and C” and “at least one of A, B, or C” refer to only A, only B, only C, both A and B, both B and C, both A and C, all A, B, and C, or any combination thereof.

In addition, the terms “ . . . part,” “ . . . module,” etc. as used herein refer to a unit that handles at least one function or operation, which may be implemented in hardware or software, or a combination of hardware and software.

Throughout the present disclosure, when a part is said to be “connected” to another part, this includes not only the case of being “directly connected” but also being “electrically connected” with another element in between. In addition, when a part is said to “include” a component, it is meant to be inclusive of other components, not exclusive of other components, unless specifically stated to the contrary.

As used throughout the present disclosure, the expression “configured to” may be used interchangeably with, for example, “suitable for,” “having the capacity to,” “designed to,” “adapted to,” “made to,” or “capable of,” depending on the context. The term “configured (or set up) to” may not necessarily mean “specifically designed to” as hardware. Instead, in some situations, the phrase “system configured to” may mean that the system is “capable of” working with other devices or components. For example, the phrase “processor configured (or set up) to perform A, B, and C” may mean a processor dedicated to performing certain operations (e.g., an embedded processor), or a generic-purpose processor (e.g., a CPU or application processor) that can perform those operations by executing one or more software programs stored in memory.

Throughout the present disclosure, terms including ordinal numbers, such as “first,” “second,” etc. may be used to describe various components, but the components are not limited by the terms. The terms are used only to distinguish one component from another. For example, without departing from the scope of the present disclosure, a first component may be named a second component, and similarly, a second component may be named a first component. The term “and/or” includes a combination of a plurality of related items or any one of a plurality of related items.

The present disclosure relates to an active optical cable (AOC), and more particularly to an active optical cable which is designed as a modular type for easy assembly and repair.

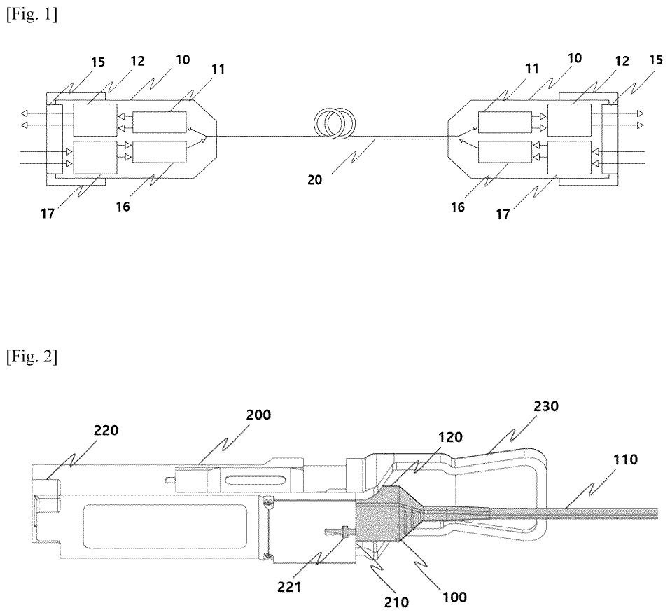

FIG. 1 is a conceptual diagram illustrating the structure of an active optical cable according to an embodiment of the present disclosure.

Referring to FIG. 1, an active optical cable (AOC) according to an embodiment of the present disclosure may comprise an optical fiber 20 and an optical transceiver 10 at both ends thereof. In an embodiment, an optical transceiver 10 may comprise an optical source 16 generating an optical signal and a driver 17 controlling the optical source 16 to convert the received electrical signal into an optical signal. For example, the optical source 16 may be configured as a laser diode or a vertical cavity surface emitting laser (VCSEL), and the driver 17 may be configured as a transmitting IC such as a laser driver. In an embodiment, the optical transceiver 10 may comprise an optical receiver 11 which receives an optical signal and converts the same into an electrical signal, and a signal processing unit 12 which performs signal processing of the converted electrical signal. For example, the optical receiver 11 may be configured as a photodiode, and the signal processing unit 12 may perform operations such as signal amplification, noise removal, signal format conversion, etc. for an electrical signal output from the optical receiver 11.

Referring to FIG. 1, an active optical cable (AOC) according to an embodiment of the present disclosure may comprise an interface unit 15, and the interface unit 15 may be configured according to a standard electrical interface. For example, the interface unit 15 may be configured according to a standard electrical interface, such as a gigabit interface converter (GBIC), small form-factor pluggable (SPF), SPF+, XFP, QSPF, QSFP+, QSFP28, CFP, etc.

FIG. 2 is a block diagram illustrating the external structure of an active optical cable according to an embodiment of the present disclosure.

Referring to FIG. 2, an active optical cable according to an embodiment of the present disclosure may comprise an optical cable module 100 and a first optical transceiver module 200. In an embodiment, the optical cable module 100 may comprise an optical cable 110 and a connector 120. In an embodiment, the first optical transceiver module 200 may comprise an insertion hole 210, an interface unit 220, and a handle unit 230.

According to an embodiment of the present disclosure, the interface unit 220 is configured as a standard electrical interface to be electrically connected with other computing devices (not shown). For example, the interface unit 220 may be configured according to a standard electrical interface, such as a gigabit interface converter (GBIC), small form-factor pluggable (SPF), SPF+, XFP, QSPF, QSFP+, QSFP28, CFP, etc.

According to an embodiment of the present disclosure, when the connector 120 of the optical cable module 100 is inserted through the insertion hole 210 of the first optical transceiver module 200, the connector 120 of the optical cable module 100 is coupled inside the first optical transceiver module 200, and the optical fiber of the optical cable 110 and the optical components of the first optical transceiver module 200 may be optically aligned. For example, the first optical transceiver module 200 and the connector 120 may be coupled in a structure that is not easy to separate without repair equipment, etc., by using interlocking concavo-convex surfaces, a latch structure, etc., to configure an active optical cable (AOC). Referring to FIG. 2, the first optical transceiver module 200 and the connector 120 are coupled through a latch structure 221 and do not comprise a separate component for separation (e.g., a release tap, etc.), so as to be used as an active optical cable (AOC), which is a single component.

According to an embodiment, single mode fiber or multi-mode fiber may be used in the optical cable module 100 and the first optical transceiver module 200. For example, multi-mode fiber may be used with a VCSEL light source, or single mode fiber may be used with a more precise laser light source. As a result, an embodiment of the present disclosure may also be applicable when comprising an optical transceiver of single mode type.

According to an embodiment, the handle unit 230 may be used to pull the active optical cable (AOC) connected to the computing device through the interface unit 220 and separate it from the computing device. The use of the handle unit 230 has an effect of avoiding damage to the optical cable 110 or the first optical transceiver module 200 during the process of separating the active optical cable. In an embodiment, the optical cable 110 may comprise an optical fiber and a sheath that protects the optical fiber.

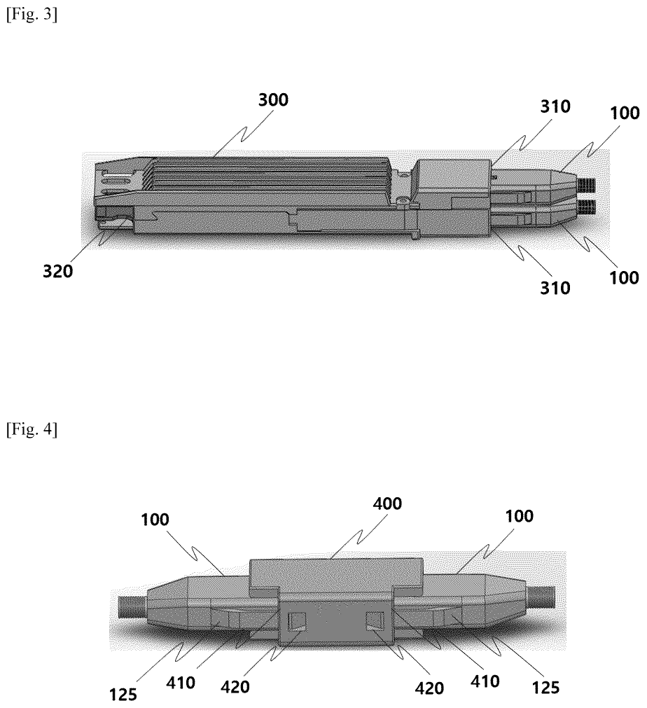

FIG. 3 is a block diagram illustrating the external structure of an active optical cable according to another embodiment of the present disclosure.

Referring to FIG. 3, an active optical cable according to an embodiment of the present disclosure may comprise a plurality of optical cable modules 100 and a second optical transceiver module 300 that can be coupled thereto. In an embodiment, the second optical transceiver module 300 may have a plurality of insertion holes 310, and the optical cable modules 100 can be coupled to each insertion hole 310. Eventually, as many optical cable modules 100 may be coupled as the number of insertion holes 310 provided in the second optical transceiver module 300. FIG. 3 illustrates a second optical transceiver module 300 capable of coupling two optical cable modules 100, but the number of insertion holes 310 that the second optical transceiver module 300 may comprise, may exceed two, and is not limited to the embodiment in FIG. 3. In an embodiment, the second optical transceiver module 300 may comprise an interface unit 320 configured as a standard electrical interface. Detailed constitution of the second optical transceiver module 300 will be described in more detail in the following.

FIG. 4 is a block diagram illustrating the external structure of a cable adaptor and an optical cable module coupled thereto according to another embodiment of the present disclosure.

Referring to FIG. 4, an optical cable adaptor 400 according to an embodiment of the present disclosure may be coupled to two optical cable modules 100 to extend the optical cable. In an embodiment, the optical cable adaptor 400 may comprise an insertion hole 410 and a cable latch groove 420 at both ends thereof. Each of the two optical cable modules 100 may be inserted into the insertion hole 410 located at both ends of the optical cable adaptor 400, and fixed by coupling a latch 125 of each optical cable module 100 to a cable latch groove 420. The two optical cable modules 100 may be optically connected by having the optical paths connected to each other while being coupled to the optical cable adaptor 400. The optical cable adaptor 400 and its coupling structure will be described in more detail in the following.

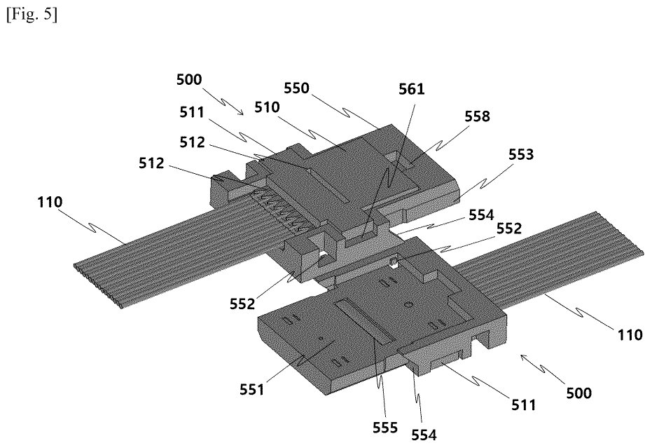

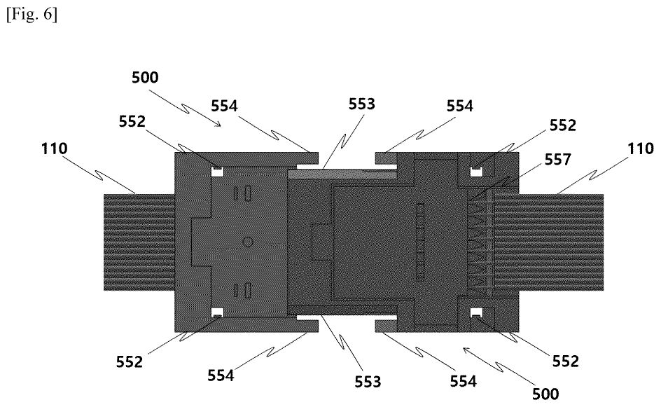

FIGS. 5 to 9 are block diagrams illustrating coupling structures of an optical connector 500 for optical coupling according to an embodiment of the present disclosure.

As described above, the optical cable module 100, the first optical transceiver module 200 and the second optical transceiver module 300 each comprise an optical connector 500 for optical coupling, and the optical connectors 500 of each module may be optically coupled to each other to form an optical path in the process of coupling two modules.

According to an embodiment, each optical connector 500 is connected to an optical cable 110, and the optical connectors 500 may comprise a structure physically coupled to each other. For example, the optical connectors 500 may comprise concavo-convex surfaces that may be coupled to each other, and the optical connectors 500 may be coupled to each other by coupling the concavo-convex surfaces of the optical connectors 500. According to an embodiment, the optical connectors 500 may comprise a structure optically coupling in the process of physically coupling each other, to form an optical path. For example, in the process of coupling the concavo-convex surfaces of the optical connectors 500, the optical connectors 500 may be configured such that an optical path capable of transmitting and receiving optical signals is aligned between the two optical connectors 500.

Referring to FIGS. 5, 6, 8 and 9, two optical connectors 500 may be coupled to each other in such a way that coupling grooves 551 formed on a bottom surface of the connectors are in contact with each other after being aligned in opposite directions. In an embodiment, the two optical connectors 500 may be coupled by pushing in opposite directions with the coupling grooves 551 partially in contact with each other. At this time, the two optical connectors 500 may be coupled at a precise location by a guide part 554 formed on the two optical connectors 500. Referring to FIG. 5, the guide part 554 may have an inclined surface in the direction of pushing the optical connectors 500 to be coupled, and a portion thereof may be formed with a different inclination so that the two optical connectors 500 no longer push each other when completely coupled. For example, the guide part 554 may be formed with a certain inclined surface and a vertical surface as illustrated in FIG. 5. In an embodiment, the two optical connectors 500 may be naturally coupled to each other along the guide parts 554 by a force pushing in opposite directions.

In an embodiment, the optical connectors 500 are located inside the optical cable module 100, the first optical transceiver module 200 or the second optical transceiver module 300, and when these modules are coupled to each other, the optical connectors 500 inside are also coupled to each other. For example, while the optical cable module 100 is inserted into the insertion hole 210, 310 of the first optical transceiver module 200 or second optical transceiver module 300, or while two optical cable modules 100 are inserted into two insertion holes 410 of the optical adaptor, the optical cable modules 100 are coupled by a force pushing in opposite directions.

In an embodiment, an optical path between two optical connectors 500 may be formed through a coupling groove 551 on the bottom surface. For example, an optical path between two optical connectors 500 may be formed through a lens 555 located in the coupling groove 551. In other words, when two optical connectors 500 are coupled to each other, the lenses 555 of the two optical connectors 500 may be fixed in positions facing each other.

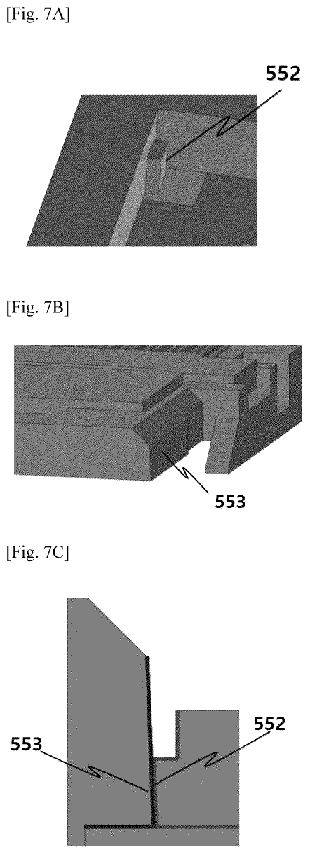

Referring to FIGS. 5, 7A, 7B, 7C, and 9, a coupling protrusion 552 of the optical connector 500 is formed to face a front side part 553 of another optical connector 500, so that the two optical connectors 500 are in close contact with each other while being coupled. In an embodiment, a coupling protrusion 552 of the optical connector 500 is formed with an inclined surface of a certain angle (with respect to the vertical direction), and the front side part 553 of the optical connector 500 is also formed with an inclined surface of the same angle in the opposite direction (with respect to the vertical direction), so that the two optical connectors 500 may be coupled along the inclined surface as illustrated in FIG. 7C. Since the coupling protrusion 552 and the front side part 553 of the optical connector 500 have inclined surfaces (gradients) in opposite directions to each other, when the two optical connectors 500 are coupled to each other along the inclined surface, the two optical connectors 500 may be precisely aligned to prevent them from deviating from each other and prevent side-to-side wobbling.

Referring to FIGS. 5 and 8, the optical connector 500 according to an embodiment may comprise a cover part 510 and a body part 550, and the cover part 510 and the body part 550 may be coupled to configure an optical connector 500. According to an embodiment, the optical fiber 20 of the optical cable 110 may be seated on an optical fiber guide 557 of the body part 550, and as the cover part 510 is coupled to the body part 550, the optical fiber 20 may be fixed therein. According to an embodiment, the optical fiber 20 of the optical cable 110 may be protected by a sheath.

According to an embodiment, the cover part 510 may comprise at least one cover protrusion 511, and the cover protrusions 511 may each be coupled to a body groove 561 of the body part 550 so that the cover part 510 and the body part 550 may be assembled. According to an embodiment, the body part 550 may comprise grooves of the same shape as at least a portion of the outer surface of the cover part 510, and the cover part 510 may be seated in the groove of the body part 550 to be coupled thereto. The gap between the inner surface of the groove of the body part 550 and the outer surface of the cover part 510 may be formed narrowly to allow an appropriate fit coupling so that the cover part 510 is well fixed to the body part 550. In an embodiment, a portion of the inner surface of the groove of the body part 550 may be formed to have a relatively wider gap from the outer surface of the cover part 510. For example, referring to FIG. 5, a portion of the inner surface of the groove of the body part 550 may form an isolation groove 558, and the cover part 510 may be easily separated from the body part 550 using the isolation groove 558 formed on the body part 550.

According to an embodiment, the cover part 510 may comprise an open groove 512 formed through the cover part 510. When the cover part 510 is coupled to the body part 550, the open groove 512 may be located above the optical fiber guide 557 on which the optical fiber 20 is seated, and a liquid material may be introduced into the optical fiber 20 through the open groove 512. According to an embodiment, the liquid material introduced through the open groove 512 may fix the at least one optical fiber 20 introduced via the optical fiber guide 557 or improve the efficiency of optical coupling. For example, the liquid introduced through the open groove 512 may be epoxy or a refractive index matching material, etc. and the fixing process using the above may block contamination that may occur on the cross-section of the at least one optical fiber 20, and minimize the refractive index difference between the cross-section of the at least one optical fiber 20 and the optical boundary surface 559, thereby reducing Fresnel reflection loss. The assembly for optical transmission and reception according to an embodiment of the present disclosure may maximize the efficiency of optical coupling using this process.

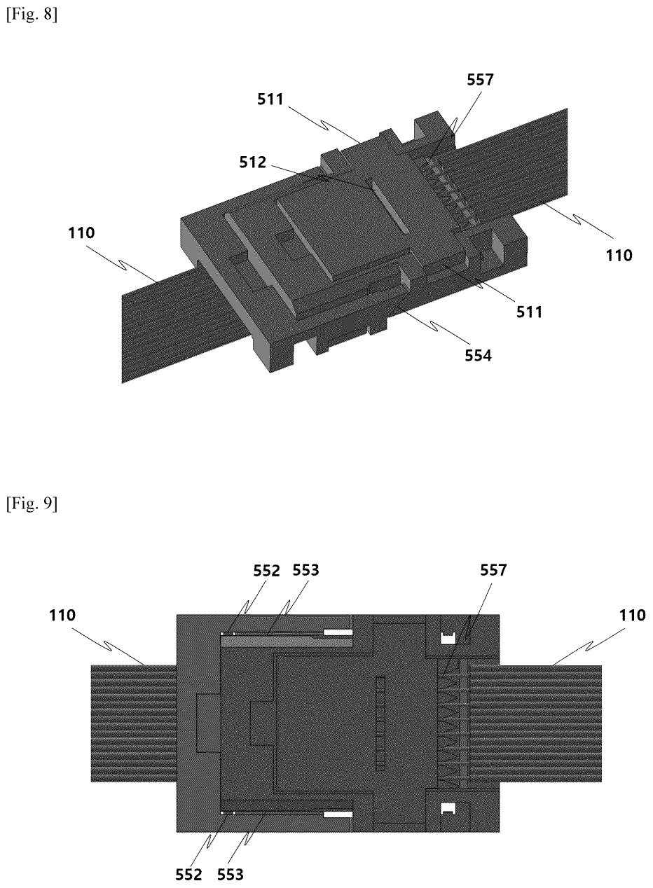

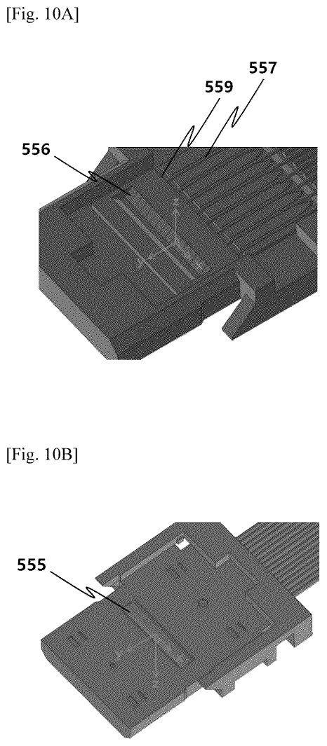

FIGS. 10A and 10B are a top perspective view and a bottom perspective view of a body part configuring an optical connector according to an embodiment of the present disclosure.

Referring to FIGS. 10A and 10B, the cross-section of the optical fiber 20 seated on the optical fiber guide 557 faces the optical boundary surface 559 of the body part 550, and the light emitted through the optical fiber 20 is incident through the optical boundary surface 559. In addition, a reflector 556 may reflect the light incident through the optical boundary surface 559 and change the direction of traveling so that the light is emitted through a lens 555 of a lower side of the body part 550. In an embodiment, the reflector 556 may selectively apply reflective coding based on whether a total reflection TR or internal total reflection TIR condition is met.

Referring to FIGS. 10A and 10B, the light emitted from the optical fiber 20 seated on the optical fiber guide 557 may pass through the optical boundary surface 559 to travel in the y-axis direction (+y), be reflected from the reflector 556 to travel in the z-axis direction (−z), and be emitted through the lens 555 of a lower side of the body part 550. In an embodiment, when two optical connectors 500 are coupled, each lens 555 is fixed in a position opposite each other. Thus, the light emitted through the lens 555 of one optical connector 500 is incident through the lens 555 of the other optical connector 500, and reflected from the reflector 556 of the other optical connector 500 in the direction of the optical fiber 20 (+y-axis direction) and incident on the optical fiber 20 through the optical boundary surface 559.

In an embodiment, the reflector 556 may perform a collimating function that converts all or a portion of the light into light traveling parallel to each other while changing the direction of traveling of the light, and may be referred to as a parallel mirror, collimating mirror, etc. For example, the reflector 556 may be configured as a prism that reflects light using the difference in refractive index between air and the medium. Referring to FIGS. 10A and 10B, the reflector 556 may be configured using grooves for forming a reflective prism. In addition, in an embodiment, the lens 555 performs a collimating function that converts all or a portion of the passing light into light traveling parallel to each other, and may be referred to as a parallel lens, collimating lens, etc.

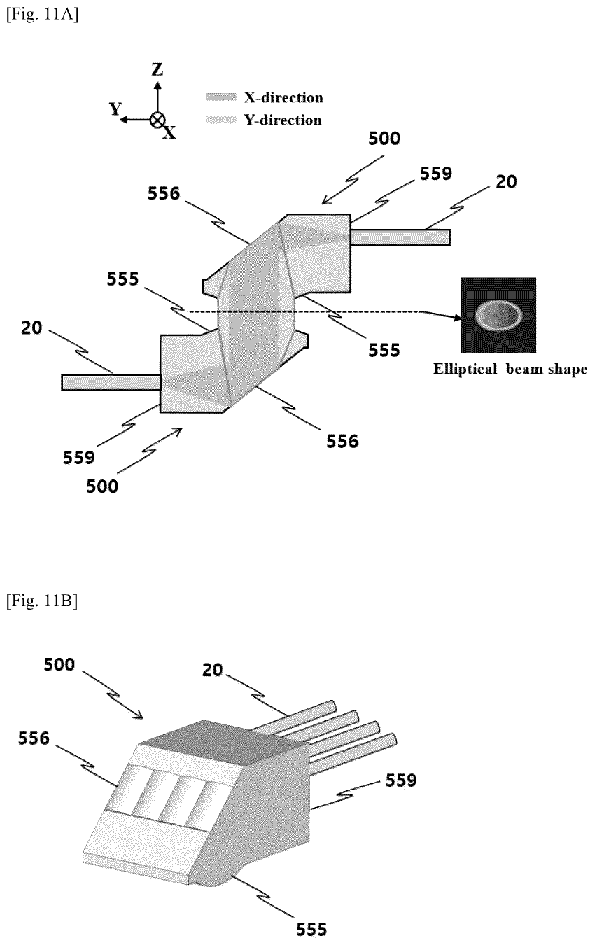

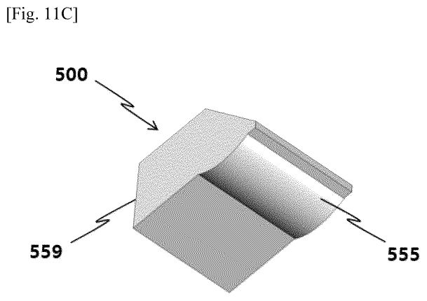

FIGS. 11A, 11B, 11C are conceptual diagrams illustrating an optical path after coupling optical connectors 500 according to an embodiment of the present disclosure.

According to an embodiment of the present disclosure, as for the optical fiber 20 in the optical connectors 500, after being seated on the optical fiber guide 557, it faces an optical boundary surface 559. The light emitted from the optical fiber 20 of the first optical connector 500 is incident through the optical boundary surface 559, and changes the direction of traveling at the reflector 556 of the first optical connector 500 to travel to the lens 555. When the first optical connector 500 and the second optical connector 500 are coupled, the lens 555 of the first optical connector 500 faces the lens 555 of the second optical connector 500. Accordingly, the light traveling to the lens 555 of the first optical connector 500 is incident on the lens 555 of the second optical connector 500, and changes the direction of traveling at the reflector 556 of the second optical connector 500 to be incident on the optical fiber 20 connected to the second optical connector 500 through the optical boundary surface 559 of the second optical connector 500.

According to an embodiment, the reflection angle of the reflector 556 may be formed at 90 degrees. Here, the reflection angle may be defined as an angle between the optical axis of light incident on the reflector 556 and the direction of traveling of the parallel beams reflected by the reflector 556. According to another embodiment, the reflection angle of the reflector 556 may be formed to be less than or greater than 90 degrees.

According to an embodiment, the lenses 555 of the first optical connector 500 and the second optical connector 500 may face each other with an air gap that is within 0.1 mm therebetween. In addition, an anti-reflection coating may be formed on the surfaces of the lenses 555 of the first optical connector 500 and the second optical connector 500.

FIG. 12 is a conceptual diagram illustrating the shape of an optical beam by a cylindrical lens.

According to an embodiment, a cylindrical lens may be used for the reflector 556 and lens 555. When the cylindrical lens is placed in the vertical direction, and light emitted and diffused from the optical fiber 20 passes through the cylindrical lens, a collimating function is performed for the traveling of light in the horizontal direction without changing the direction of traveling of light in the vertical direction. Referring to FIG. 12, with respect to a cylindrical lens placed in the y-axis direction (vertical direction) and having a cross-section formed as an arc in the z-axis direction (direction of traveling of light), when light is emitted from an optical fiber placed in the z-axis direction and passes through the cylindrical lens, the light is collimated in the x-axis direction (horizontal direction) and is no longer diffused, but the light continues to diffuse in the y-axis direction (vertical direction).

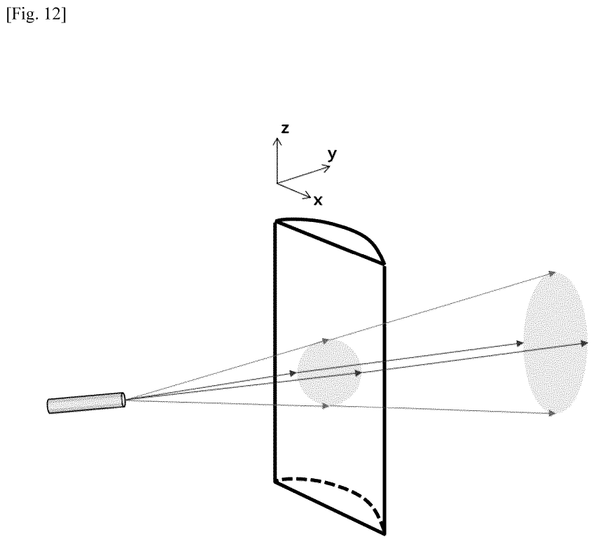

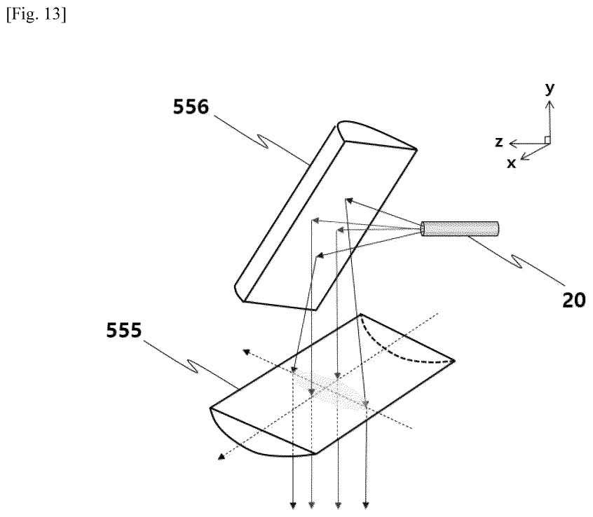

FIG. 13 is a conceptual diagram illustrating the traveling of light when the reflector and the lens are cylindrical lens according to an embodiment of the present disclosure.

In an embodiment, a cylindrical lens may be adopted for a reflector 556 and a lens 555. Referring to FIG. 10, the reflector 556 may be formed as a separate cylindrical lens for each optical fiber 20, and the lens 555 may be formed as one cylindrical lens as a whole. Referring to FIG. 13, light emitted from an optical fiber 20 placed in the z-axis direction passes through the optical boundary surface 559 to reach the reflector 556, and the direction of traveling of light changes in the reflector 556 (referring to FIG. 13, from the z-axis direction to the −y-axis direction), so as to face the lens 555. The reflector 556 is configured as a cylindrical lens to reflect light, so that light in the horizontal direction (x-axis direction) of the cylindrical lens, which is the reflector 556, is collimated and becomes parallel light, and light continues to diverge in the vertical direction (y-axis direction) of the cylindrical lens.

In an embodiment, light reaching the lens 555, which is a cylindrical lens, is collimated in the horizontal direction (z-axis direction) of the cylindrical lens while passing through the lens 555 to be parallel light. The lens 555 does not change the direction of traveling of light in the vertical direction (x-axis direction) of the cylindrical lens, but the vertical direction (x-axis direction) of the cylindrical lens is already collimated by the reflector 556, which is a cylindrical lens, and thus is configured as parallel light. Eventually, light passing through the lens 555, which is a cylindrical lens, is collimated in all directions and emitted as perfectly parallel light.

According to an embodiment, when light emitted from the optical fiber 20 is collimated in the x-axis direction by the reflector 556, there is no optical crosstalk between the channels in the x-axis direction. Since the light emitted from the optical fiber 20 is not limited by optical crosstalk in the y-axis direction, the light reaches the lens 555 of the bottom surface in a divergent state without being collimated by the reflector 556. The light that reaches the lens 555 of the bottom surface travels parallel to the x-axis direction and continues to diverge in the z-axis direction (due to the change in the direction of light by the reflector), forming an elliptical optical beam with a larger diameter in the z-axis direction, resulting in a relatively larger beam size than when the light is collimated in all directions by the reflector 556. As a result, it has a larger beam size, and thus has an effect of further reducing the influence of dust particles, etc. on the optical signal. In addition, in order to collimate light in all directions, the complexity of mold processing to process the reflector 556 with complex shapes of aspherical and elliptical shapes is avoided, and only processing of a cylindrical surface with a simple shape is required, which has the advantage of enabling easier mold processing and reducing shape errors.

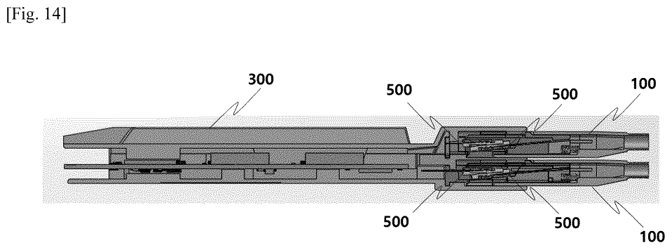

FIG. 14 is a cross-sectional view illustrating the interior of the active optical cable of FIG. 3 according to an embodiment of the present disclosure.

Referring to FIG. 14, an active optical cable according to an embodiment of the present disclosure may comprise a second optical transceiver module 300 comprising two insertion holes 310 and two optical cable modules 100 coupled to each insertion hole 310. Since each insertion hole 310 of the second optical transceiver module 300 comprises an optical connector 500, the second optical transceiver module 300 comprises as many optical connectors 500 as the number of insertion holes 310. For example, the second optical transceiver module 300 in FIG. 14 comprises two insertion holes, and thus comprises two optical connectors 500. The optical connector 500 of the insertion hole 310 is optically coupled to the optical connector 500 in the optical cable module 100 coupled to the insertion hole 310 to form an optical path. Eventually, two optical connectors 500 are coupled to each other within each insertion hole 310 of the second optical transceiver module 300 to form an optical path. The second optical transceiver module 300 comprising a plurality of insertion holes 310 may be coupled to the plurality of optical cable modules 100 in the vertical direction.

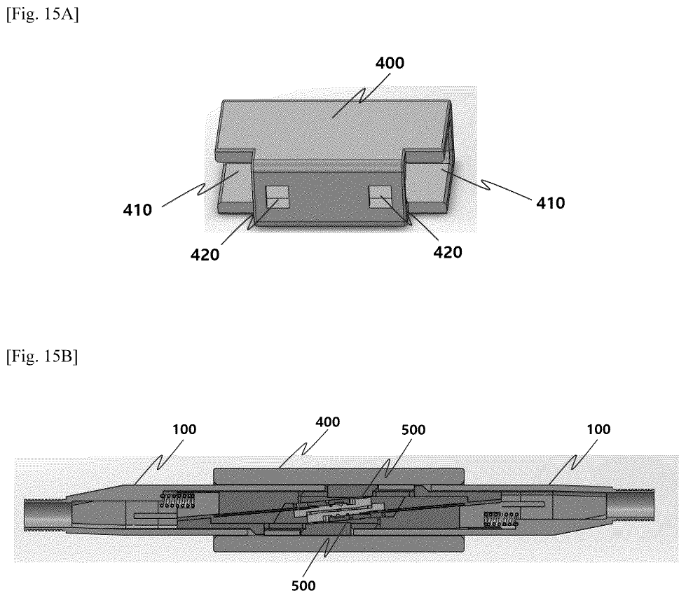

FIGS. 15A and 15B are cross-sectional views illustrating the interior of the optical cable adapter of FIG. 4 according to an embodiment of the present disclosure.

Referring to FIGS. 15A and 15B, an active optical cable according to an embodiment of the present disclosure may comprise an optical cable adaptor 400 comprising two insertion holes 410 and two optical cable modules 100 coupled to the respective insertion holes 410. As already described above with reference to FIG. 4, the optical cable adaptor 400 is for optically coupling the two optical cable modules 100 to extend the optical cable. In an embodiment, the optical cable adaptor 400 does not comprise a separate optical connector 500, and the optical connectors 500 of the two optical cable modules 100 may be directly coupled to each other inside the optical cable adaptor 400. Referring to FIGS. 15A and 15B, the optical connectors 500 of the two optical cable modules 100 may be optically coupled inside the optical cable adaptor 400 while the optical cable modules 100 are inserted into the insertion holes of the optical cable adaptor 400 to be coupled.

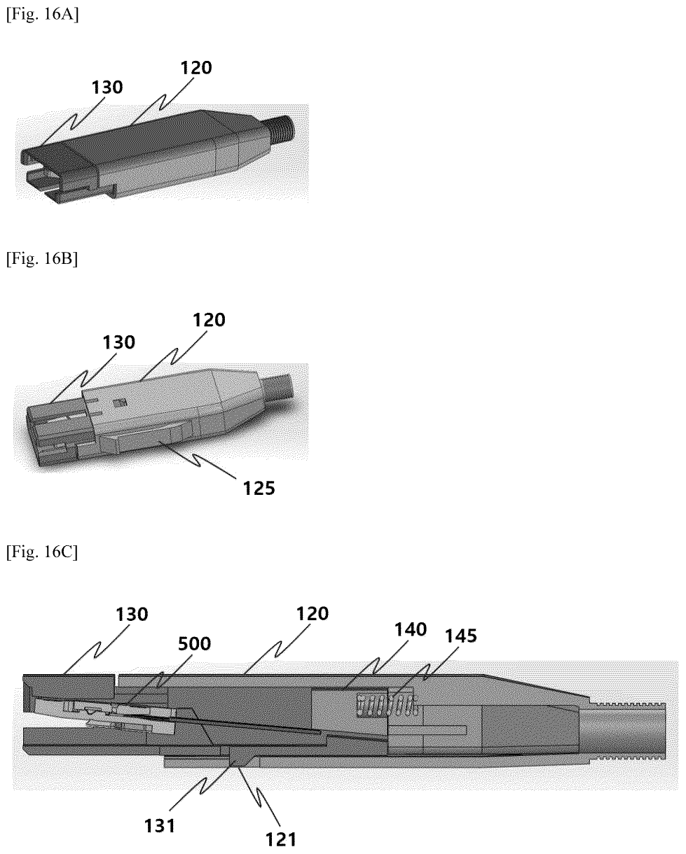

FIGS. 16A, 16B, and 16C are perspective views and a cross-sectional view illustrating the configuration of an optical cable module according to an embodiment of the present disclosure.

Referring to FIGS. 16A, 16B, and 16C, in an embodiment, the optical cable module 100 may comprise a housing part 120 and a cassette part 130. In an embodiment, the cassette part 130 may be inserted into the housing part 120 to be coupled, and may be connected to the optical cable 110 through the housing part 120. For example, a latch 131 of the cassette part 130 may be fastened and coupled to the latch groove 121 of the housing part 120. In an embodiment, the cassette part 130 may comprise an optical connector 500, and may be connected to the optical cable 110 through the inside of the housing part 120. In an embodiment, an optical fiber and spring fixing block 140 may be installed between the housing part 120 and the cassette part 130 to allow the cassette part 130 to move back and forth using the elasticity of the spring 145 to guide the optical fiber 20 into a constant inclined state.

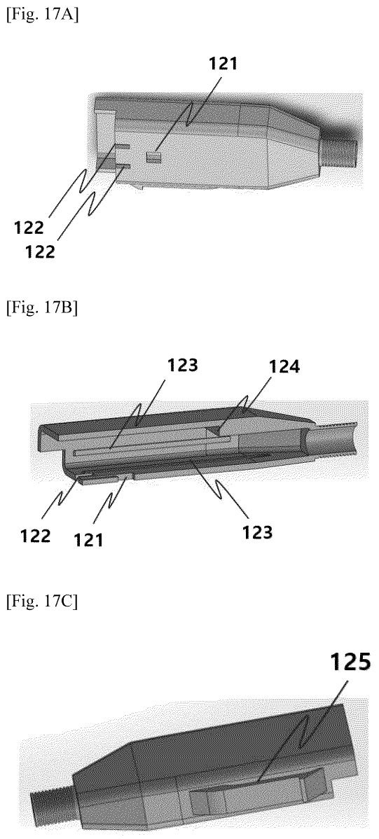

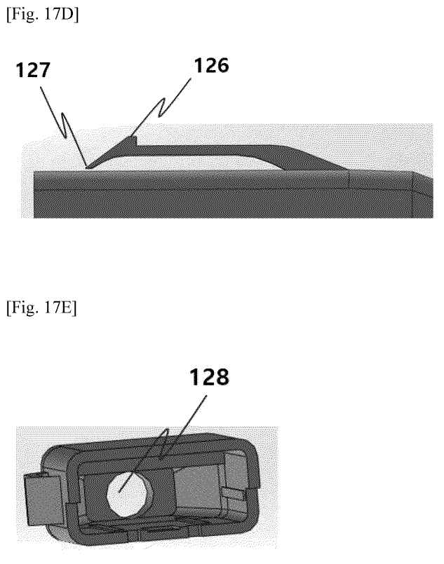

FIGS. 17A, 17B, 17C, 17D, and 17E are perspective views and cross-sectional views illustrating the configuration of a housing part according to an embodiment of the present disclosure.

Referring to FIGS. 17A, 17B, 17C, 17D, and 17E, one surface of the housing part 120 may comprise a latch groove 121 to be coupled to the cassette part 130, and may also comprise a lobe avoidance groove 122 for preventing the cable from another module from being reverse-inserted or colliding. The lobe avoidance groove 122 is designed to be coupled to the guiding protrusion 344 of the cassette part 340 or the anti-collision and anti-reverse-insertion protrusion 660 of the divider insert 600, and to be held on the guiding protrusion 344 or the anti-collision and anti-reverse-insertion protrusion 660 when the cassette part 340 or the divide insert 600 is assembled in the wrong direction. For example, when there is an attempt to assemble the cassette part 340 or the divider insert 600 in the housing part 120 with the top and bottom reversed, the guiding protrusion 344 or the anti-collision and anti-reverse-insertion protrusion 660 may be configured to be held on the housing part 120 to prevent assembly.

In an embodiment, the housing part 120 may comprise a guiding lobe 123 for guiding the cassette part 130 when the cassette part 130 is being inserted therein, and a spring fixing protrusion 124 formed at a predetermined location where a spring 145 is mounted to deliver elasticity to the cassette part 130. In an embodiment, one surface of the housing part 120 may comprise a latch 125 to be coupled to another module, and the latch 125 may comprise a holding protrusion 126 that may be coupled to a latch groove of another module, and a retaining protrusion 127 that supports the holding protrusion 126 from the opposite direction to prevent the holding protrusion 126 from falling out of the latch groove. In an embodiment, the housing part 120 may comprise an incoming hole 128 through which the optical cable 110 may income from a direction opposite to the direction in which the cassette part 130 is inserted.

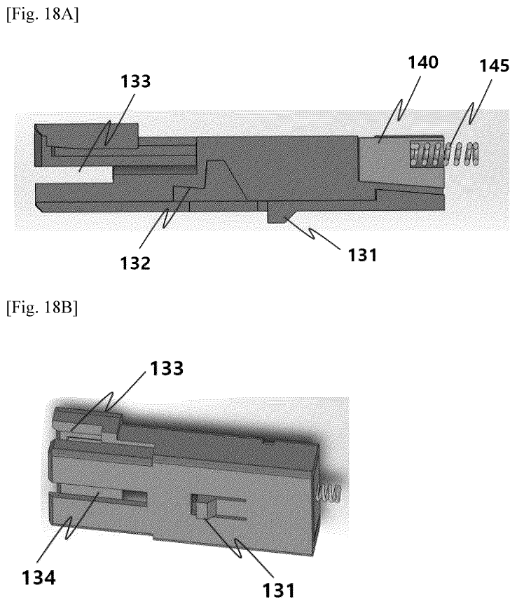

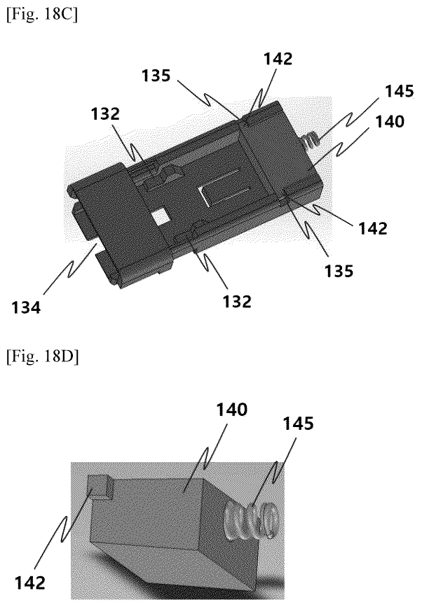

FIGS. 18A, 18B, 18C, and 18D are perspective views and cross-sectional views illustrating the configuration of a cassette part according to an embodiment of the present disclosure.

Referring to FIGS. 18A, 18B, 18C, and 18D, one surface of the cassette part 130 may comprise a latch 131 to be coupled to the housing part 120, and an optical connector seating part 132 for seating the optical connector 500. In an embodiment, the optical connector seating part 132 may be formed with an inclined surface to allow the optical connector 500 to be installed at a certain angle.

In an embodiment, the cassette part 130 may comprise a cassette overlapping groove 133 coupled to overlap with another cassette part 130, and an optical connector anti-tip block avoidance groove 134 so as not to be held on an optical connector anti-tip block 136 when coupled to overlap with another cassette part 130. In an embodiment, the cassette part 130 may comprise a fixing groove 135 for fixing the optical fiber and spring fixing block 140, and a fixing protrusion 142 of the optical fiber and spring fixing block 140 may be fixedly coupled to the fixing groove 135 of the cassette part 130.

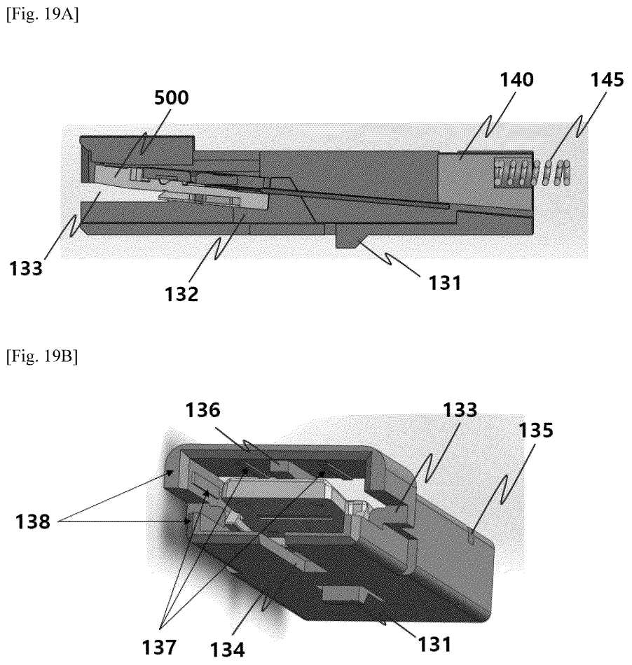

FIGS. 19A and 19B are a perspective view and a cross-sectional view illustrating the configuration of a cassette part to which an optical connector is coupled according to an embodiment of the present disclosure.

Referring to FIGS. 19A and 19B, the cassette part 130 may comprise a cassette guiding protrusion 137 guiding the movement of another cassette part 130 when coupled to overlap with another cassette part 130. In an embodiment, the cassette part 130 may comprise a cassette guiding tapered part 138 in which an end that meets first is processed in a taping shape so as to allow smooth movement when coupled to overlap with another cassette part 130.

Referring to FIGS. 19A and 19B, the optical connector 500 may be installed within the cassette part 130 at a certain angle along the angle of the seating surface of the optical connector seating part 132.

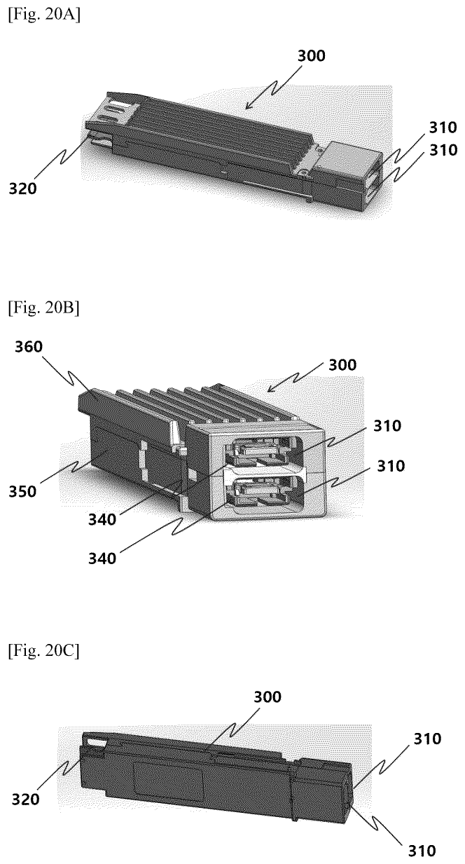

FIGS. 20A, 20B, and 20C are perspective views illustrating the configuration of a second optical transceiver module according to an embodiment of the present disclosure.

Referring to FIGS. 20A, 20B, and 20C, the second optical transceiver module 300 may comprise a plurality of insertion holes 310 to be coupled to respective optical cable modules 100, and an interface unit 320 configured as a standard electrical interface. In an embodiment, each insertion hole 310 of the second optical transceiver module 300 may comprise a cassette part 130, and each cassette part 130 may comprise one optical connector 500.

In an embodiment, the second optical transceiver module 300 may comprise a housing part 330 and a plurality of cassette parts 340. For example, the second optical transceiver module 300 may comprise one cassette part 340 for each insertion hole 310.

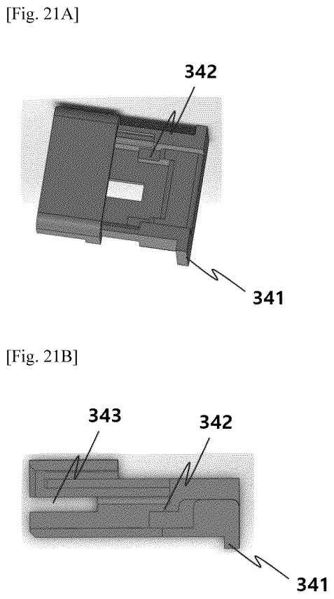

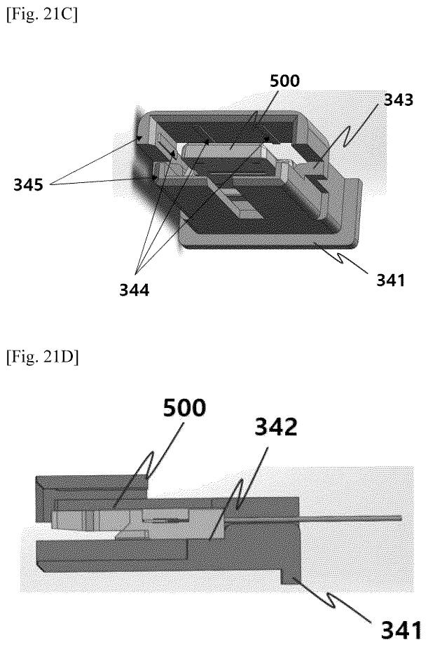

FIGS. 21A, 21B, 21C, and 21D are a perspective view and a cross-sectional view of a cassette part used in a second optical transceiver module according to an embodiment of the present disclosure.

Referring to FIGS. 21A, 21B, 21C, and 21D, the cassette part 340 used in the second optical transceiver module 300 may comprise a protrusion 341 to be fixed to the insertion hole 331 of the housing part 330, and an optical connector seating part 342 for seating the optical connector 500. In an embodiment, the optical connector seating part 342 may be formed as a horizontal surface. In another embodiment, the optical connector seating part 342 may be formed with an inclined surface to allow the optical connector 500 to be installed at a certain angle.

In an embodiment, the cassette part 340 may comprise a cassette overlapping groove 343 coupled to overlap with another cassette part 340. Referring to FIG. 21, the cassette part 340 may comprise a cassette guiding protrusion 344 guiding the movement of another cassette part 340 when coupled to overlap with another cassette part 340. In an embodiment, the cassette part 340 may comprise a cassette guiding tapered part 345 in which an end that meets first is processed in a taping shape so as to allow smooth movement when coupled to overlap with another cassette part 340.

Referring to FIGS. 21A, 21B, 21C, and 21D, the optical connector 500 may be installed horizontally within the cassette part 340 along the seating surface of the horizontally formed optical connector seating part 342.

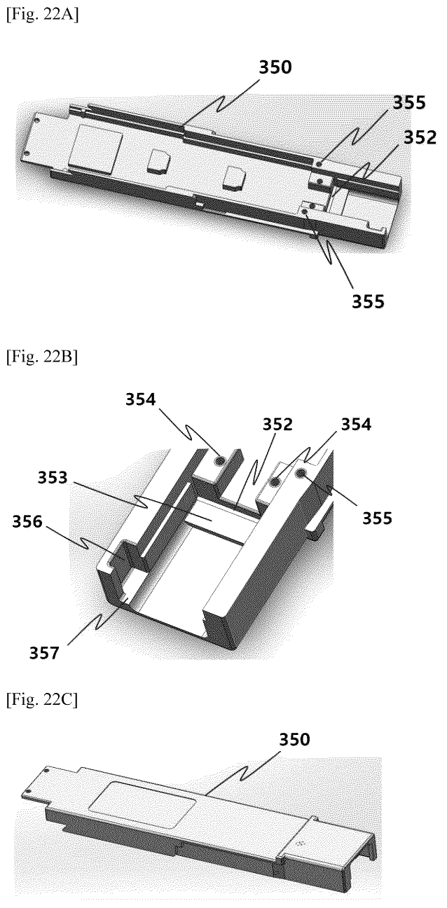

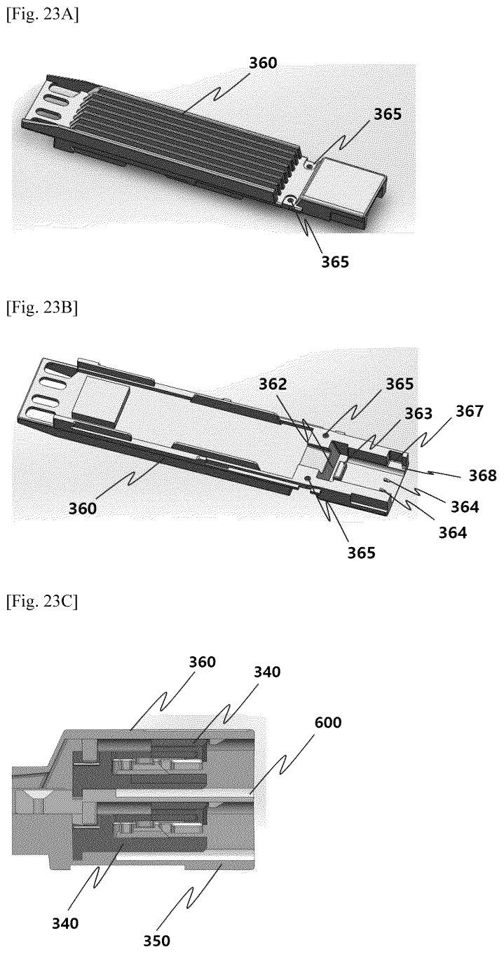

FIGS. 22A, 22B, 22C, 23A, 23B, and 23C are exploded perspective views illustrating a housing part used in a second optical transceiver module according to an embodiment of the present disclosure.

Referring to FIGS. 22A, 22B, 22C, 23A, 23B, and 23C, the housing part 330 used in the second optical transceiver module 300 may comprise a lower housing part 350 and an upper housing part 360, and the lower housing part 350 and the upper housing part 360 may be screw-coupled using a fastening screw groove 355.

Referring to FIGS. 22A, 22B, and 22C, the lower housing part 350 may comprise an insertion groove 352 that may be coupled to a protrusion 341 of the cassette part 340, and a cassette seating part 353 on which the cassette part 340 may be seated. In an embodiment, the lower housing part 350 may comprise a fastening screw groove 354 for coupling the divider insert 600 inserted so that a cassette part 340 may be additionally seated on the cassette part 340. In an embodiment, the lower housing part 350 may comprise a latch fixing groove 356 on which a latch 640 of the divider insert 600 is seated for fixing the divider insert 600, and a latch guiding groove 357 for smooth insertion of the divider insert 600.

Referring to FIGS. 23A, 23B, and 23C, the upper housing part 360 may comprise an insertion groove 362 coupled to a protrusion 341 of the cassette part 340, and a pressing protrusion 363 for press-fixing the optical fiber 20. In an embodiment, the upper housing part 360 may comprise an anti-collision and anti-reverse-insertion protrusion 364 of the cassette part 340, a latch fixing groove 367 on which a latch 640 of the divider insert 600 is seated for fixing the divider insert 600, and a latch guiding groove 368 for smooth insertion of the divider insert 600.

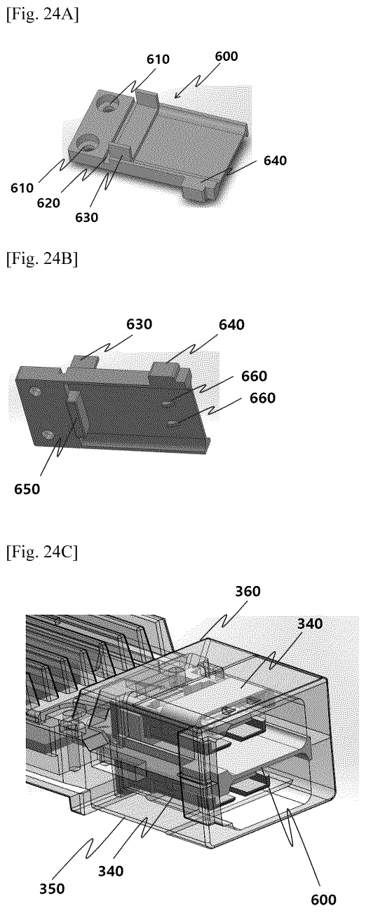

FIGS. 24A, 24B, and 24C are a top perspective view, a bottom perspective view, and a coupled view of a divider insert 600 according to an embodiment of the present disclosure.

Referring to FIGS. 24A, 24B, and 24C, the divider insert 600 may comprise a coupling screw hole 610 to be coupled to the lower housing part 350, and a latch 640 to be smoothly inserted and fixed to the lower housing part 350 and the upper housing part 360. In an embodiment, the divider insert 600 may comprise an insertion groove 620 to be coupled to a protrusion 341 of the cassette part 340, and a cassette seating part 630 on which the cassette part 340 may be seated.

In an embodiment, the divider insert 600 may comprise a pressing protrusion 650 for press-fixing the optical fiber 20, and an anti-collision and anti-reverse-insertion protrusion 660 of the cassette part 340.

Referring to FIGS. 23A, 23B, 23C, 24A, 24B and 24C, a first optical transceiver module 300 may be configured by first coupling one cassette part 340 on a lower housing part 350, coupling a divider insert 600 thereon, coupling another cassette part 340, and finally coupling an upper housing part 360.

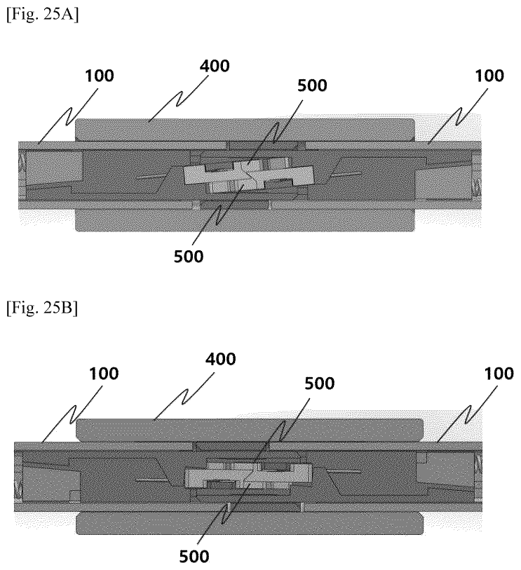

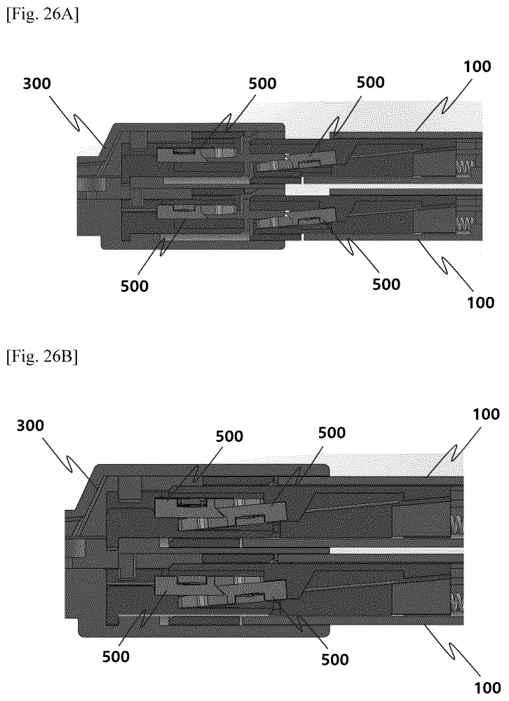

FIGS. 25A and 25B are cross-sectional views illustrating a coupling method of optical connectors in an optical cable module according to an embodiment of the present disclosure.

In an embodiment, the optical connector 500 of the optical cable module 100 may be installed at a certain angle, and referring to FIG. 25, when the optical cable module 100 is inserted into two insertion holes 410 of the optical cable adaptor 400 to be coupled, the optical connectors 500 start coupling while maintaining a certain angle as illustrated in FIG. 25A, and after being completely coupled, may be fixed in a horizontal direction as illustrated in FIG. 25B.

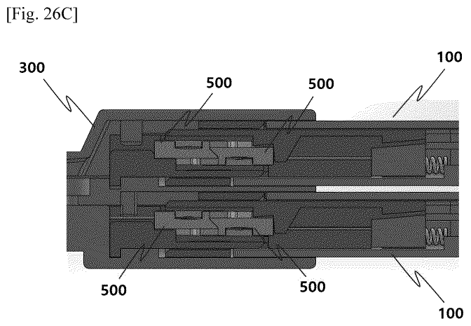

FIGS. 26A, 26B, and 26C are cross-sectional views illustrating a coupling method of optical connectors in a second optical transceiver module according to an embodiment of the present disclosure.

Referring to FIG. 26A, the optical connector 500 in the second optical transceiver module 300 may be installed horizontally, and the optical connector 500 within the optical cable module 100 may be installed in a state inclined at a certain angle. Referring to FIGS. 26B and 26C, when the optical cable module 100 is inserted into the insertion hole 310 of the second optical transceiver module 300 to be coupled, the optical connectors 500 of the optical cable module 100 start coupling while maintaining a certain angle as illustrated in FIG. 26B, and after being completely coupled, may be fixed in a horizontal direction as illustrated in FIG. 25C and FIG. 25E.

The active optical cable according to an embodiment of the present disclosure may comprise an optical cable adaptor 400 comprising two insertion holes 410, and two optical cable modules 100 coupled to the respective insertion holes 410. As already described above referring to FIG. 4, the optical cable adaptor 400 is for optically coupling the two optical cable modules 100 to extend the optical cable. In an embodiment, the optical cable adaptor 400 does not comprise a separate optical connector 500, and the optical connectors 500 of the two optical cable modules 100 may be directly coupled to each other inside the optical cable adaptor 400. Referring to FIG. 14, the optical connectors 500 of the two optical cable modules 100 are optically coupled inside the optical cable adaptor 400 while the optical cable modules 100 are inserted into the insertion holes of the optical cable adaptor 400 to be coupled.

The above description is merely an exemplary description of the technical idea of the embodiments, and a person skilled in the art can make various modifications and variations within a scope not departing from the essential features of the embodiments. Accordingly, the embodiments are intended to illustrate, not to limit, the technical idea of the embodiments, and the scope of the technical idea of the embodiments is not limited by these embodiments. The scope of protection of the embodiments should be construed in accordance with the claims below, and all technical ideas within the scope of the equivalents thereof should be construed to be included in the scope of the claims of the embodiments.

What is claimed is:

1. An optical connector, comprising:
an optical boundary surface on which light emitted from an optical fiber is incident;
a reflector changing a direction of traveling of light incident through the optical boundary surface; and
a lens emitting light reflected through the reflector outside,
wherein the reflector has a cylindrical shape and converts light incident on the reflector into light traveling parallel to a first direction, and
the lens has a cylindrical shape and converts light incident on the lens into light traveling parallel to a second direction which is perpendicular to the first direction.

2. The optical connector of claim 1, wherein the first direction is perpendicular to both the direction of light incident on the reflector and the direction of reflection.

3. The optical connector of claim 1, wherein the second direction is perpendicular to both the direction of light incident on the lens and the first direction.

4. The optical connector of claim 1, wherein the light emitted through the lens has a wider width in the second direction than in the first direction and travels in parallel.

5. The optical connector of claim 1, wherein the reflector is a prism in a form of a cylindrical lens.

6. The optical connector of claim 1, wherein the lens is a cylindrical lens.

7. The optical connector of claim 1, wherein the direction of light incident on the lens is changed by the reflector to be incident on the optical fiber.

8. The optical connector of claim 1, wherein the optical connector is bottom-to-bottom coupled to another optical connector.

9. The optical connector of claim 8, wherein the optical connector, when coupled to another optical connector, has a lens of the optical connector facing a lens of the another optical connector.

10. The optical connector of claim 8, comprising: parts coupled in a gradient structure in opposite directions to each other when coupled with another optical connector.

11. The optical connector of claim 10, wherein the parts coupled in a gradient structure in opposite directions to each other are a coupling protrusion and a front side part.

12. The optical connector of claim 8, comprising guide parts formed at opposite inclinations to each other to guide smooth coupling when coupled with another optical connector.

13. The optical connector of claim 1, wherein the optical connector is coupled with a plurality of optical fibers, comprises reflectors in equal numbers as the optical fibers, and comprises the one lens.

14. The optical connector of claim 1, comprising a body part and a cover part.

15. The optical connector of claim 14, wherein the cover part and the body part have protrusions and grooves fittedly coupled to each other.

16. The optical connector of claim 14, wherein the body part comprises an optical fiber guide capable of seating at least one optical fiber.

17. An optical cable module comprising the optical connector of claim 1.

18. An optical transceiver module comprising the optical connector of claim 1.

19. An active optical cable, comprising:
an optical cable module comprising the optical connector of claim 1; and
an optical transceiver module comprising the optical connector of claim 1.

20. An active optical cable, comprising:
two optical cable modules; and
an optical transceiver module comprising two insertion holes,
wherein the optical cable module comprises the optical connector of claim 1, the insertion hole allows the optical cable modules to be coupled one by one, and the insertion hole comprises the optical connector of claim 1.
